(19) United States
(12) Patent Application Publication
(10) Pub. No.: US 2026/0088599 A1
(43) Pub. Date: Mar. 26, 2026

(54) BUS BAR CONNECTION ASSEMBLY

(71) Applicant: Bellwether Electronic Corp., Taoyuan City (TW)

(72) Inventor: Yi-Chieh LO, Taoyuan City (TW)

(21) Appl. No.: 19/296,985

(22) Filed: Aug. 12, 2025

Related U.S. Application Data
(60) Provisional application No. 63/698,576, filed on Sep. 25, 2024.

(51) Int. Cl. H02G 5/02

(52) U.S. Cl. CPC H02G 5/02

(57) ABSTRACT

A bus bar connection assembly includes a bus bar body, a first conductive terminal set, a second conductive terminal set and a third conductive terminal set. The bus bar body includes a first configuration area, a second configuration area and a connecting portion connected to the first configuration area and the second configuration area. The first conductive terminal set is arranged on the first configuration area and electrically connected to the bus bar body. The second conductive terminal set is arranged on the second configuration area, electrically connected to the bus bar body, and provided with a first protruding length. The third conductive terminal set is arranged on the second configuration area, electrically connected to the bus bar body, and has a second protruding length different from the first protruding length.

### RELATED APPLICATIONS

This application claims priority to U.S. Provisional Application Ser. No. 63/698,576, filed Sep. 25, 2024, which is herein incorporated by reference in its entirety.

### BACKGROUND

### Field of Invention

The present disclosure relates to a bus bar connection assembly. More particularly, the present disclosure relates to a bus bar connection assembly capable of transmitting large current.

### Description of Related Art

With the advancement of technology, electronic products have been significantly improved in terms of functionality, efficiency and intelligence. Therefore, large working currents must be needed to be transmitted between electronic units inside an electronic product while the electronic product is operating.

However, as the working current being transmitted increases, the size of the components for transmitting the working current will be increased. For example, increased number of cables, or used thicker cables, resulting the increasing of electronic product in size.

Therefore, the above-mentioned technology apparently is still with inconvenience and defects and needed to be further developed. Hence, how to develop a solution to improve the foregoing deficiencies and inconvenience is an important issue that relevant persons engaged in the industry are currently unable to delay.

### SUMMARY

One aspect of the present disclosure is to provide a bus bar connection assembly for solving the difficulties mentioned above in the prior art.

In one embodiment of the present disclosure, a bus bar connection assembly includes a bus bar body, a first conductive terminal set, a second conductive terminal set and a third conductive terminal set. The bus bar body includes a first configuration area, a second configuration area and a connecting portion connected to the first configuration area and the second configuration area. The first conductive terminal set is configured to be located on the first configuration area and electrically connected to the bus bar body. The second conductive terminal set is configured to be located on the second configuration area, electrically connected to the bus bar body, and provided with a first protruding length. The third conductive terminal set is configured to be located on the second configuration area, electrically connected to the bus bar body, and provided with a second protruding length different from the first protruding length.

In one embodiment of the present disclosure, a bus bar connection assembly includes a bus bar body, a first conductive terminal set and a second conductive terminal set. The bus bar body includes a first configuration area, a second configuration area and a connecting portion. The connecting portion is connected to the first configuration area and the second configuration area, and formed with an opening arranged between the first configuration area and the second configuration area. The first conductive terminal set is configured to be located on the first configuration area and electrically connected to the bus bar body. The second conductive terminal set is configured to be located on the second configuration area, electrically connected to the bus bar body.

In one embodiment of the present disclosure, a bus bar connection assembly includes a bus bar body, a first conductive terminal set and a second conductive terminal set. The bus bar body includes a first configuration area, a second configuration area, and a connecting portion connected to the first configuration area and the second configuration area. The first conductive terminal set is configured to be located on the first configuration area and electrically connected to the bus bar body. The second conductive terminal set is configured to be located on the second configuration area, electrically connected to the bus bar body. The bus bar body includes a first conductive plate, a second conductive plate and an insulating plate, and the insulating plate is sandwiched between the first conductive plate and the second conductive plate to fixedly bond the first conductive plate and the second conductive plate together, the second conductive plate partially exposes a non-covered area of the first conductive plate in the first configuration area.

Thus, through the construction of the embodiments above, the bus bar connection assembly of the disclosure can transmit large currents between working units without causing damage, thus avoiding failure of electronic products and shortening of product life.

The above description is merely used for illustrating the problems to be resolved, the technical methods for resolving the problems and their efficacies, etc. The specific details of the present disclosure will be explained in the embodiments below and related drawings.

### BRIEF DESCRIPTION OF THE DRAWINGS

The disclosure can be more fully understood by reading the following detailed description of the embodiment, with reference made to the accompanying drawings as follows.

FIG. 1 is a perspective view of a bus bar power transmission device according to one embodiment of the present disclosure.

FIG. 2 is an exploded view of the bus bar power transmission device of FIG. 1.

FIG. 3 is a cross-sectional view of FIG. 1 along a line A-A.

FIG. 4 is a cross-sectional view of FIG. 1 along a line B-B.

FIG. 5 is a cross-sectional view of FIG. 1 along a line C-C.

FIG. 6 is a cross-sectional view of FIG. 1 along a line D-D.

FIG. 7 is a side view of the bus bar power transmission device of FIG. 1.

### DETAILED DESCRIPTION

Reference will now be made in detail to the present embodiments of the present disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the present disclosure.

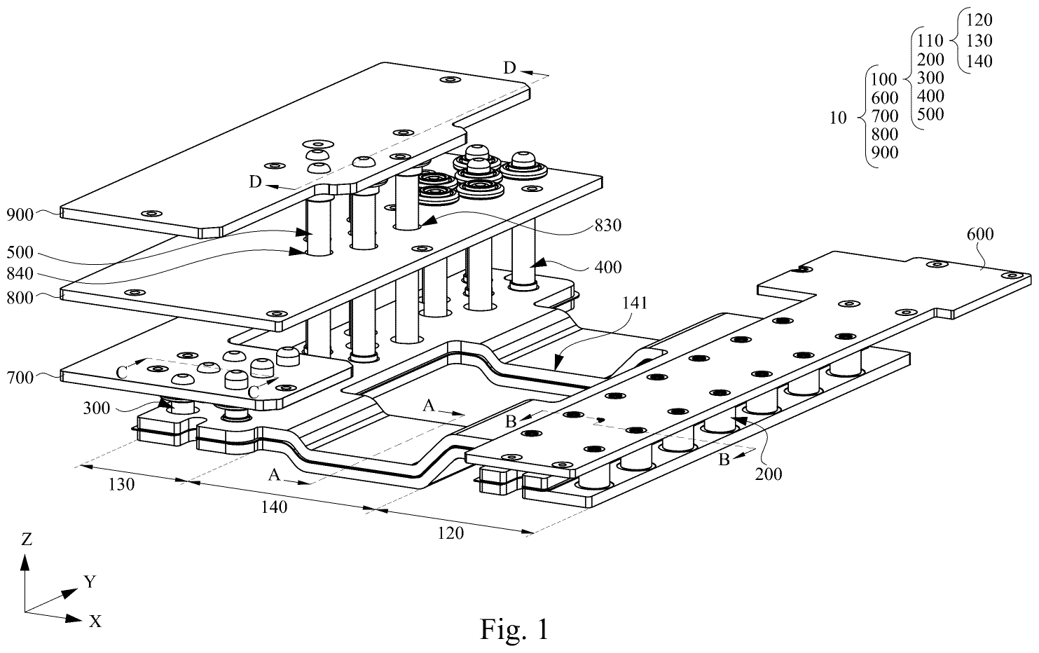

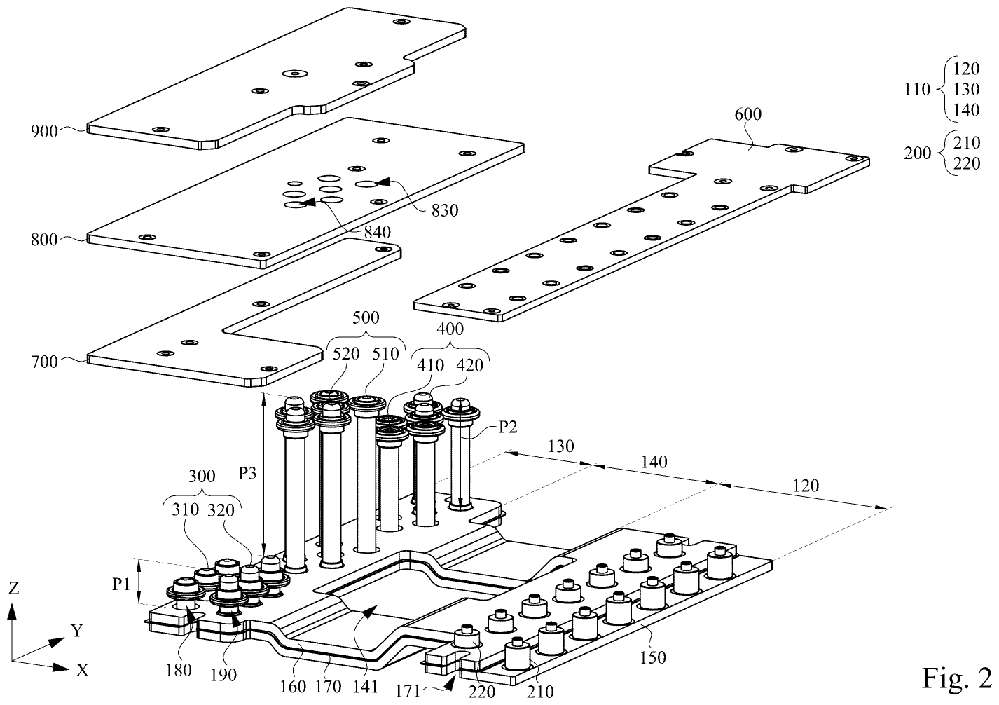

FIG. 1 is a perspective view of a bus bar power transmission device 10 according to one embodiment of the present disclosure. FIG. 2 is an exploded view of the bus bar power transmission device 10 of FIG. 1. As shown in FIG. 1 to FIG. 2, in the embodiment, the bus bar power transmission device 10 includes a bus bar connection assembly 100, a first working unit 600, a second working unit 700, a third working unit 800 and a fourth working unit 900. The first working unit 600 is placed opposite to the second working unit 700. The bus bar connection assembly 100, the second working unit 700, the third working unit 800 and the fourth working unit 900 are spaced placed abreast along a vertical direction (e.g., Z axis). The second working unit 700 is electrically connected to one power supply (not shown in figures), the third working unit 800 is electrically connected to another power supply (not shown in figures) different from the power supply described above, and the fourth working unit 900 is electrically connected to the other power supply (not shown in the figure). The first working unit 600 to the fourth working unit 900 are, for example, any circuit board or electronic component, however, the present disclosure is not limited thereto.

The bus bar connection assembly 100 includes a bus bar body 110, a first conductive terminal set 200, a second conductive terminal set 300, a third conductive terminal set 400 and a fourth conductive terminal set 500. The bus bar body 110 includes a first configuration area 120, a second configuration area 130 and a connecting portion 140 connected between the first configuration area 120 and the second configuration area 130. In this embodiment, the first configuration area 120, the second configuration area 130 and the connecting portion 140 are integrally formed and connected to each other, however, the disclosure is not limited thereto.

The first conductive terminal set 200 is located on the first configuration area 120 and electrically connected to the bus bar body 110 and the first working unit 600. The second conductive terminal set 300 is located on the second configuration area 130, for example, at one end of the second configuration area 130. The second conductive terminal set 300 is electrically connected to the bus bar body 110 and the second working unit 700. The third conductive terminal set 400 is located on the second configuration area 130, for example, at the other end of the second configuration area 130. The third conductive terminal set 400 is electrically connected to the bus bar body 110 and the third working unit 800. The fourth conductive terminal set 500 is located on the second configuration area 130, for example, between the second conductive terminal set 300 and the third conductive terminal set 400. The fourth conductive terminal set 500 is electrically connected to the bus bar body 110 and the fourth working unit 900.

The second conductive terminal set 300 is provided with a first protruding length P1 extending outwards from the bus bar body 110 along the vertical direction (e.g., Z axis). The third conductive terminal set 400 is provided with a second protruding length P2 extending outwards from the bus bar body 110 along the Z axis, and different from the first protruding length P1, for example, greater than the first protruding length P1. The fourth conductive terminal set 500 is provided with a third protruding length P3 extending outward from the bus bar body 110 along the Z axis, and the second protruding length P2 is smaller than the third protruding length P3 and larger than the first protruding length P1.

Since the protruding lengths P1, P2, P3 of the second conductive terminal set 300, the third conductive terminal set 400 and the fourth conductive terminal set 500 are respectively different, the bus bar connection assembly 100 can be connected to objects with different heights (e.g., the second working unit 700 to the fourth working unit 900). In this way, the bus bar connection assembly 100 can transmit the large current transmitted from the second working unit 700, the third working unit 800 and/or the fourth working unit 900 to the first working unit 600. Alternatively, the large current transmitted from the first working unit 600 is divided and transmitted to the second working unit 700, the third working unit 800 and the fourth working unit 900.

The connecting portion 140 is formed with an opening 141. The opening 141 may be presented as a closed contour or an open opening, and located between the first configuration area 120 and the second configuration area 130. Thus, when the bus bar power transmission device 10 is installed, the opening 141 of the connecting portion 140 allows other components (such as cooling devices) to pass through, thereby improving the spatial configuration. The heights (e.g., the positions in Z axis) of the first configuration area 120, the second configuration area 130 and the connecting portion 140 may be the same or different. For example, the first configuration area 120 and the second configuration area 130 are at the same height, while the connecting portion 140 is at a different height, or all three are different. With such a configuration, the bus bar connection assembly 100 can be used in different application environments.

In addition, two opposite sides of the bus bar body 110 respectively have positioning members 171, such as grooves, bumps or positioning holes, for positioning or fixing the bus bar connection assembly 100. The positioning members 171 can be disposed on the first configuration area 120, the second configuration area 130 and/or the connecting portion 140. In this embodiment, the positioning members 171 are plural, which are disposed on the first configuration area 120 and the second configuration area 130, respectively.

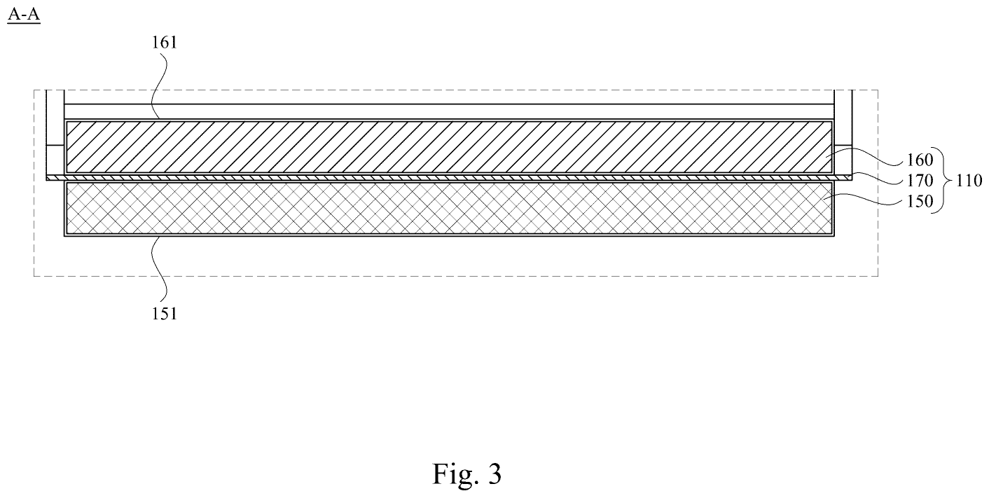

FIG. 3 is a cross-sectional view of FIG. 1 along a line A-A. As shown in FIG. 2 and FIG. 3, in the embodiment, the bus bar body 110 includes a first conductive plate 150, a second conductive plate 160 and an insulating plate 170. The insulating plate 170 is sandwiched between the first conductive plate 150 and the second conductive plate 160 and electrically isolated from the first conductive plate 150 and the second conductive plate 160. The insulating plate 170 may completely cover the overlapping area of the second conductive plate 160 and the first conductive plate 150 to ensure that the first conductive plate 150 and the second conductive plate 160 are completely isolated. With such a configuration, the first conductive plate 150 and the second conductive plate 160 can respectively transmit currents of different potentials, such as a positive potential and a ground potential.

Furthermore, in this embodiment, the bus bar body 110 bonds the first conductive plate 150, the second conductive plate 160 and the insulating plate 170 together by heat pressing, so that the insulating plate 170 can be fixedly bonded with the first conductive plate 150 and the second conductive plate 160.

Furthermore, in the present embodiment, for example, the first conductive plate 150 and the second conductive plate 160 are respectively metal plates with high conductivity (e.g., copper or aluminum, etc.) with a thickness of 3 mm or more, and the insulating plate 170 is a non-metallic plate with electrical insulation properties (e.g., polyethylene terephthalate, PET or alumina, Al₂O₃) with a thickness of 0.4 mm or more, however, the disclosure is not limited to this.

It is noted, in order to prevent the first conductive plate 150 and/or the second conductive plate 160 from accidentally forming a short circuit with other conductors, furthermore, the outer surfaces of the first conductive plate 150 is further coated with a first insulating coating film 151, and the outer surfaces of the second conductive plate 160 is further coated with a second insulating coating film 161, and the first insulating coating film 151 and the second insulating coating film 161 can be electrically connected to the above-mentioned first conductive terminal set 200 to the fourth conductive terminal set 500 through a conductive area (e.g., via hole) on the bus bar body 110.

As shown in FIG. 2, the first conductive terminal set 200 includes a plurality of first-A conductive posts 210 and a plurality of first-B conductive posts, which are connected to the first configuration area 120 of the bus bar body 110, respectively. One end of each of the first-A conductive posts 210 is electrically connected to the first conductive plate 150, and electrically isolated from the second conductive plate 160. One end of each of the first-B conductive posts 220 is electrically connected to the second conductive plate 160, and electrically isolated from the first conductive plate 150. The first-A conductive posts 210 are spaced arranged from each other along Y axis, and the first-B conductive posts 220 are spaced arranged from each other along the Y axis.

The first-A conductive posts 210 (or the first-B conductive posts 220) may be cylindrical, and the diameter (hereinafter referred to as D1) thereof is equal to or greater than 8 mm, and a gap (i.e. the shortest distance, hereinafter referred to as D2) of any two adjacent ones of the first-A conductive posts 210 is equal to or greater than 20 mm. The ratio of D2/D1 is preferably 1.5 or above. A shortest distance (hereinafter referred to as D3) between one of the first-A conductive posts 210 and one of the first-B conductive posts 220 is equal to or greater than D2. The first-B conductive posts 220 and the first-A conductive posts 210 may also be arranged in a single row or in an array.

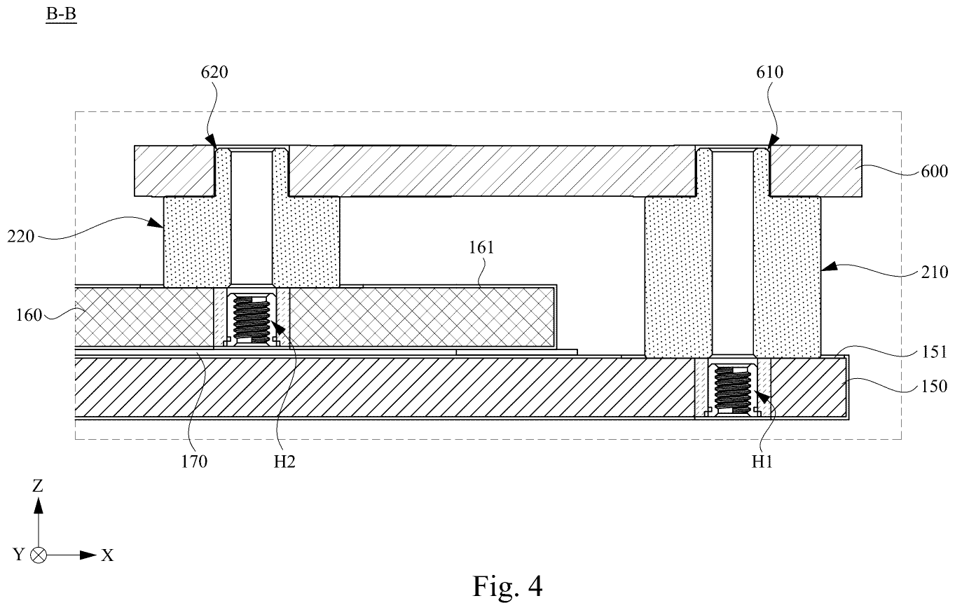

FIG. 4 is a cross-sectional view of FIG. 1 along a line B-B. As shown in FIG. 2 and FIG. 4, in the embodiment, the second conductive plate 160 is located between the first conductive plate 150 and the first working unit 600. Compared with the first conductive plate 150, the second conductive plate 160 is closer to the first working unit 600. The other end of one of the first-A conductive posts 210 is electrically connected to one of first contacts 610 of the first working unit 600. Since the second conductive plate 160 has not completely covered the first conductive plate 150 in the first configuration area 120, a non-covered area of the first conductive plate 150 is formed thereof (see FIG. 2 and FIG. 4). Each of the first-A conductive posts 210 is allowed to pass the first insulating coating film 151 (or a contact area of the first conductive plate 150 not covered by the first insulating coating film 151) to insert into one of contact holes H1 of the non-covered area of the first conductive plate 150 or directly contact the contact area of the first conductive plate 150 for electrical connection, however, each of the first-A conductive posts 210 does not contact with the second conductive plate 160 for electrical isolation. The other end of one of the first-B conductive posts 220 is electrically connected to one of second contacts 620 of the first working unit 600. Each of the first-B conductive posts 220 is allowed to pass the second insulating coating film 161 (or a contact area of the second conductive plate 160 not covered by the second insulating coating film 161) to insert into one of contact holes H2 of the second conductive plate 160 or directly contact with the contact area of the second conductive plate 160 for electrical connection, however, each of the first-B conductive posts 220 does not contact with the first conductive plate 150 for electrical isolation.

As shown in FIG. 2, the second conductive terminal set 300 includes a plurality of second-A conductive posts 310 and a plurality of second-B conductive posts 320. The second-A conductive posts 310 are linearly arranged along the Y axis, and the second-B conductive posts 320 are linearly arranged along the Y axis. That is, the second-B conductive posts 320 and the second-A conductive posts 310 are arranged in a row on the second configuration area 130.

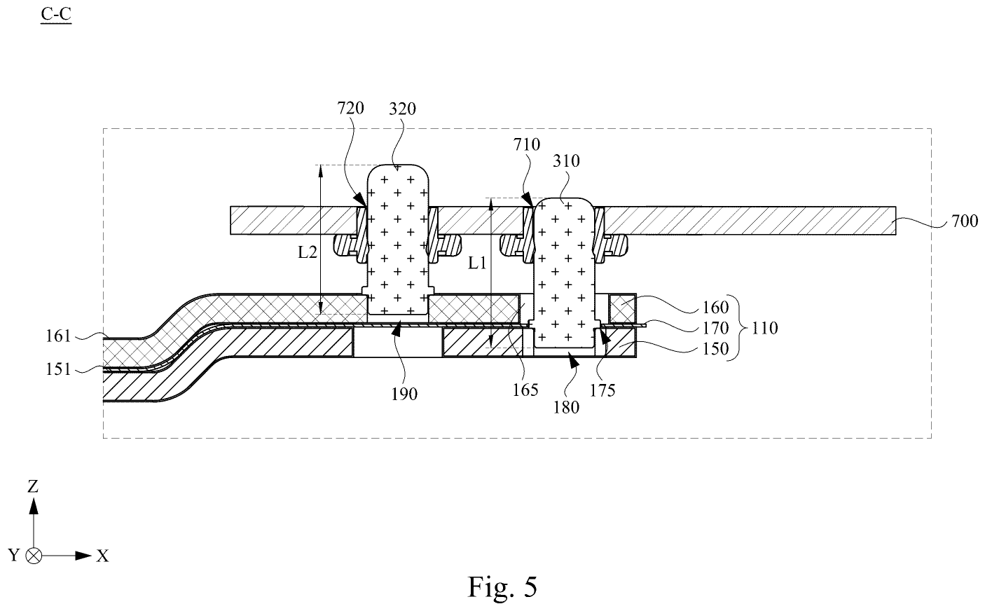

FIG. 5 is a cross-sectional view of FIG. 1 along a line C-C. As shown in FIG. 2 and FIG. 5, in the embodiment, one end of each of the second-A conductive posts 310 is electrically connected to the first conductive plate 150, for example, inserted into the second configuration area 130 of the bus bar body 110, and not contacted with the second conductive plate 160 for electrical isolation, and the other end of each of the second-A conductive posts 310 is electrically connected to the first contact 710 of the second working unit 700. One end of each of the second-B conductive posts 320 is electrically connected to the second conductive plate 160, for example, inserted into the bus bar body 110, and not contacted with the first conductive plate 150 for electrical isolation, and the other end of each of the second-B conductive posts 320 is electrically connected to the second contact 720 of the second working unit 700. The second configuration area 130 may be configured in the same manner as the first configuration area 120, and the second conductive plate 160 does not completely cover the first conductive plate 150, or the second conductive plate 160 completely covers the first conductive plate 150. The first contact 710 and the second contact 720 may be conductive sockets, which are installed on and electrically connected to the second working unit 700. The second-A conductive post 310 and the second-B conductive post 320 may be detachably inserted into the conductive sockets to achieve electrical connection with the second working unit 700. Each of the conductive socket may have a hollow slot and an elastic conductive member (e.g., crown spring) installed within the hollow slot, so that the conductive socket is electrically connected to the second-A conductive post 310 (or the second-B conductive post 320) through the elastic conductive member.

More specifically, the bus bar body 110 includes a plurality of first via holes 180 and a plurality of second via holes 190. The first via holes 180 are formed on the first conductive plate 150, and each of the first via holes 180 is a blind hole with single opening at one end thereof, or a through hole with two openings at two opposite ends thereof. The second via holes 190 are formed on the second conductive plate 160, and each of the second via holes 190 is a blind hole or a through hole. If the second conductive plate 160 completely covers the first conductive plate 150, as shown in FIG. 5, the second conductive plate 160, located at the upper layer of the bus bar body 110, is further formed with one or more first through holes 165 respectively corresponding to the first via holes 180 of the first conductive plate 150, located at the lower layer of the bus bar body 110, so as to completely expose the first via holes 180. At the same time, the insulating plate 170, located at the middle layer of the bus bar body 110, is further formed with one or more second through holes 175 respectively corresponding to the via holes 180 of the first conductive plate 150, located at the lower layer of the bus bar body 110 to completely expose the second through holes 175. The first through holes 165 (or second through holes 175) can be correspondingly aligned with the first via holes 180 in a one-to-one or one-to-multiple manner. In the one-to-one case, the size of each of the first through hole 165 is larger than the size of each of the first via holes 180, so that each of the second-A conductive post 310 is not in physical contact with the second conductive plate 160 when passing through the corresponding first through hole 165. For example, the first through holes 165, the second through hole 175 and the first via holes 180 are hollow circular holes. Any of the diameter of the first through hole 165 and the diameter of the second through holes 175 is greater than that of one of the first via holes 180, and the first through hole 165 and the second through hole 175 are concentric circles when viewed in the vertical direction (e.g., Z axis). The inner wall of each of the first via holes 180 (or the second via holes 190) is not covered with the first insulating coating film 151 (or the second insulating coating film 161), and the surface of the first conductive plate 150 (or the second conductive plate 160) facing the second working unit 700 and an area (i.e., contact extension area) adjacent to the first via hole 180 (or the second via hole 190) may also be not covered with the first insulating coating film 151 (or the second insulating coating film 161). At the same time, the first through hole 165 and the second through hole 175 also expose a portion of the surface (i.e., contact extension area) of the first conductive plate 150 to increase the contact area with the second-A conductive post 310 (or second-B conductive post 320). However, the inner wall of the first through hole 165 is covered with the second insulating coating film 161, so that when the second-A conductive post 310 is in contact with the second conductive plate 160 due to installation error, the second-A conductive post 310 and the second conductive plate 160 are still electrically isolated.

One section of each of the second-A conductive posts 310 is inserted into the corresponding first via hole 180 to be electrically connected to the first conductive plate 150, the middle section thereof passes through the insulating plate 170 and the second conductive plate 160 in sequence, and the other section thereof is electrically connected to the second working unit 700. One section of each of the second-B conductive posts 320 is inserted into the corresponding second via hole 190, and electrically connected to the second conductive plate 160 through this second via hole 190, and the other section thereof is electrically connected to the second working unit 700.

Furthermore, the length L1 of the second-A conductive post 310 and the length L2 of the second-B conductive post 320 can be equal. Since the first conductive plate 150 and the second conductive plate 160 are located at different positions in Z axis, the protruding length of the second-A conductive post 310 on the second configuration area 130 (FIG. 1) is smaller than the protruding length of the second-B conductive post 320 on the second configuration area 130 (FIG. 1). More specifically, the protruding length of the second-A conductive post 310 protruded from the second conductive plate 160 along Z axis is smaller than the protruding length of the second-B conductive post 320 protruded from the second conductive plate 160 along Z axis. In some embodiments, the length L1 of the second-A conductive post 310 and the length L2 of the second-B conductive post 320 may be unequal, so that the protruding lengths of the second-A conductive post 310 and the second-B conductive post 320 on the second configuration area 130 (FIG. 1) are equal.

As shown in FIG. 2, the third conductive terminal set 400 includes a plurality of third-A conductive posts 410 and a plurality of third-B conductive posts 420. The third-A conductive posts 410 are linearly spaced along the Y axis, the third-B conductive posts 420 are linearly spaced along the Y axis, and the third-B conductive posts 420 and the third-A conductive posts 410 are alternately arranged on the second configuration area 130. The configuration area of the third conductive terminal set 400 does not overlap with the second working unit 700 on the X-Y plane (e.g., a plane perpendicular to the Z axis).

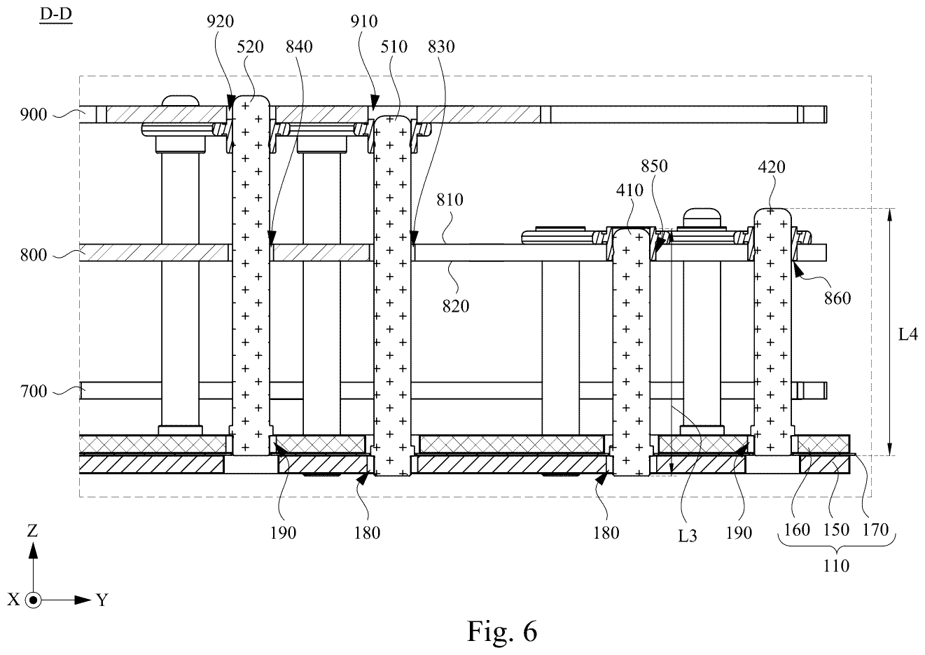

FIG. 6 is a cross-sectional view of FIG. 1 along a line D-D. As shown in FIG. 2 and FIG. 6, one end of each of the third-A conductive posts 410 is electrically connected to the first conductive plate 150 of the second configuration area 130 of the bus bar body 110, and the other end of each of the third-A conductive posts 410 is electrically connected to one of first contacts 850 of the third working unit 800. One end of each of the third-B conductive posts 420 is electrically connected to the second conductive plate 160 of the second configuration area 130, and the other end of each of the third-B conductive posts 420 is electrically connected to one of second contacts 860 of the third working unit 800.

Either a length L3 of each of the third-A conductive posts 410 or a length L4 of each of the third-B conductive posts 420 is greater than a length L1 of each of the second-A conductive posts 410, or greater than a length L2 of each of the second-B conductive posts 420. The corresponding relationship between the third conductive terminal set 400 and the bus bar body 110 is equivalent to that of the second conductive terminal set 300, and will not be repeated here.

Similarly, as shown in FIG. 2, the fourth conductive terminal set 500 includes a plurality of fourth-A conductive posts 510 and a plurality of fourth-B conductive posts 520. These fourth-A conductive posts 510 and fourth-B conductive posts 520 are arranged alternately on the second configuration area 130. One end of each of the fourth-A conductive posts 510 is electrically connected to the first conductive plate 150, and the other end thereof is electrically connected to one of first contacts 910 of the fourth working unit 900. One end of each fourth-B conductive posts 520 is electrically connected to the second conductive plate 160, and the other end of each of the fourth-B conductive posts 520 is electrically connected to one of second contacts 920 of the fourth working unit 900. Either a length (no reference) of each of the fourth-A conductive posts 510 or a length (no reference) of each of the fourth-B conductive posts 520 is greater than the length L3 of each of the third-A conductive posts 410 (FIG. 6), or greater than the length L4 of each of the third-B conductive posts 420 (FIG. 6). The corresponding relationship between the fourth conductive terminal set 500 and the bus bar body 110 can be equivalent to the description above, and will not be repeated here. The following only describes the differences.

In this embodiment, the configuration area of the fourth conductive terminal set 500 overlaps with the third working unit 800 on the X-Y plane (i.e., a plane perpendicular to the Z axis), but does not overlap with the second working unit 700. Therefore, the third working unit 800 is further formed with a plurality of first insulating through holes 830 and a plurality of second insulating through holes 840. Each of the first insulating through holes 830 passes through the third working unit 800 to connect to two opposite surfaces 810, 820 of the third working unit 800. Each of the second insulating through holes 840 passes through the third working unit 800 to connect the opposite surfaces 810, 820 of the third working unit 800. Each of the fourth-A conductive posts 510 is inserted through one of the first insulating through holes 830, and separated from the inner wall of the first insulating through hole 830 by a gap. Each of the fourth-B conductive posts 520 is inserted through one of the second insulating through holes 840, and separated from the inner wall of the second insulating through hole 840 by a gap.

In this embodiment, one end of each of the above-mentioned second-A to fourth-A conductive posts 310, 410, 510 and one end of each of the above-mentioned second-B to fourth-B conductive posts 320, 420, 520 individually have an integral or detachable structure (e.g., knurled pin and bolt etc.), so as to well electrically connect to the corresponding first via hole 180 and the second via hole 190, respectively.

Regarding to the sizes and arrangements of the first conductive terminal set 200, the second conductive terminal set 300, the third conductive terminal set 400 and the fourth conductive terminal set 500 as well as the configurations of the first conductive plate 150 and the second conductive plate 160 on the first configuration area 120 and the second configuration area 130 In the above description can be interchanged and applied without affecting the efficacy of the present application.

It is noted, in other embodiments, the present application can omit the configuration of the fourth working unit 900 and the fourth conductive terminal set 500 to meet other needs or restrictions.

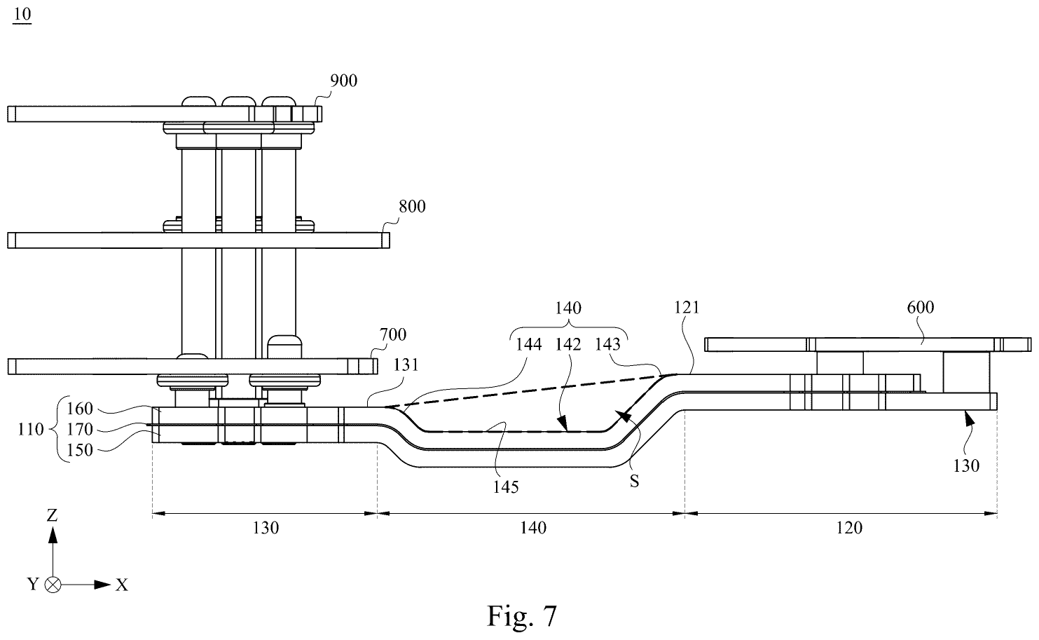

FIG. 7 is a side view of the bus bar power transmission device 10 of FIG. 1. As shown in FIG. 2 and FIG. 7, the bus bar body 110 includes a three-dimensional shape, such as a wave shape, thereby possessing a recessed structure for serving as a component positioning function. More specifically, the planar height of the top surface 131 of the second configuration area 130 is greater than the planar height of the top surface 145 of the connecting portion 140, and less than the planar height of the top surface 121 of the first configuration area 120. The top surface 131, the top surface 145, and the top surface 121 are parallel to each other in the X-Y plane (i.e., the plane perpendicular to the Z axis). The connecting portion 140 further includes a connecting body 142, a first inclined portion 143, and a second inclined portion 144. The connecting body 142 is connected to the first inclined portion 143 and the second inclined portion 144. The connecting body 142 is connected to the first configuration area 120 through the first inclined portion 143. The connecting body 142 is connected to the second configuration area 130 through the second inclined portion 144. A recessed space S is defined by the connecting body 142, the first inclined portion 143 and the second inclined portion 144. In this way, the recessed space S can provide more flexible design options for the component configuration program.

Thus, through the construction of the embodiments above, the bus bar connection assembly of the disclosure can transmit large currents between working units without causing damage, thus avoiding failure of electronic products and shortening of product life.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A bus bar connection assembly, comprising:
a bus bar body comprising a first configuration area, a second configuration area and a connecting portion connected to the first configuration area and the second configuration area;
a first conductive terminal set that is configured to be located on the first configuration area and electrically connected to the bus bar body;
a second conductive terminal set that is configured to be located on the second configuration area, electrically connected to the bus bar body, and provided with a first protruding length; and
a third conductive terminal set that is configured to be located on the second configuration area, electrically connected to the bus bar body, and provided with a second protruding length different from the first protruding length.

2. The bus bar connection assembly of claim 1, wherein the bus bar body comprises a first conductive plate, a second conductive plate and an insulating plate, and the insulating plate is sandwiched between the first conductive plate and the second conductive plate to fixedly bond the first conductive plate and the second conductive plate together.

3. The bus bar connection assembly of claim 2, wherein the bus bar body further comprises a first insulating coating film coated on outer surfaces of the first conductive plate, and a second insulating coating film coated on outer surfaces of the second conductive plate.

4. The bus bar connection assembly of claim 2, wherein the second conductive plate partially exposes a non-covered area of the first conductive plate in the first configuration area, and
the first conductive terminal set comprises at least one first-A conductive post and at least one first-B conductive post, the at least one first-A conductive post is electrically connected to the non-covered area of the first conductive plate, and the at least one first-B conductive post is electrically connected to the second conductive plate.

5. The bus bar connection assembly of claim 2, wherein the second conductive terminal set comprises at least one second-A conductive post and at least one second-B conductive post, the at least one second-A conductive post is inserted into the bus bar body, and electrically connected to the first conductive plate, and the at least one second-B conductive post is electrically connected to the second conductive plate; and
the third conductive terminal set comprises at least one third-A conductive post and at least one third-B conductive post, the at least one third-A conductive post is inserted into the bus bar body, and electrically connected to the first conductive plate, and the at least one third-B conductive post is electrically connected to the second conductive plate.

6. The bus bar connection assembly of claim 5, wherein the second conductive plate comprises at least one first through hole in the second configuration area, the insulating plate comprises at least one second through hole corresponding to the at least one first through hole, and the at least one second-A conductive post is electrically connected to the first conductive plate through the at least one first through hole and the at least one second through hole.

7. The bus bar connection assembly of claim 5, wherein a protruding length of the at least one second-A conductive post in the second configuration area is smaller than a protruding length of the at least one second-B conductive post in the second configuration area.

8. The bus bar connection assembly of claim 5, wherein a length of the at least one second-A conductive post is equal to a length of the at least one second-B conductive post, and smaller than a length of the at least one third-A conductive post, a length of the at least one third-A conductive post is equal to a length of the at least one third B conductive post.

9. The bus bar connection assembly of claim 1, wherein the connecting portion is formed with an opening, and the opening is presented as a closed contour, and connected to the first configuration area and the second configuration area.

10. The bus bar connection assembly of claim 1, wherein a plane height of a top surface of the second configuration area and a plane height of a top surface of the first configuration area are greater than a plane height of a top surface of the connecting portion.

11. A bus bar connection assembly, comprising:
a bus bar body comprising a first configuration area, a second configuration area and a connecting portion that is connected to the first configuration area and the second configuration area and formed with an opening arranged between the first configuration area and the second configuration area;
a first conductive terminal set configured to be located on the first configuration area and electrically connected to the bus bar body; and
a second conductive terminal set configured to be located on the second configuration area, electrically connected to the bus bar body.

12. The bus bar connection assembly of claim 11, wherein the bus bar body comprises a first conductive plate, a second conductive plate and an insulating plate, and the insulating plate is sandwiched between the first conductive plate and the second conductive plate to fixedly bond the first conductive plate and the second conductive plate together.

13. The bus bar connection assembly of claim 12, wherein the second conductive plate partially exposes a non-covered area of the first conductive plate in the first configuration area, and the first conductive terminal set comprises at least one first-A conductive post and at least one first-B conductive post, the at least one first-A conductive post is electrically connected to the non-covered area of the first conductive plate, and the at least one first-B conductive post is electrically connected to the second conductive plate.

14. The bus bar connection assembly of claim 12, wherein the second conductive terminal set comprises at least one second-A conductive post and at least one second-B conductive post, the at least one second-B conductive post is electrically connected to the second conductive plate, the second conductive plate comprises at least one first through hole in the second configuration area, the insulating plate comprises at least one second through hole corresponding to the at least one first through hole, and the at least one second-A conductive post is electrically connected to the first conductive plate through the at least one first through hole and the at least one second through hole.

15. The bus bar connection assembly of claim 11, wherein a top surface of the second configuration area, a top surface of the first configuration area and a top surface of the connecting portion are different in plane heights.

16. A bus bar connection assembly, comprising:
a bus bar body comprising a first configuration area, a second configuration area, and a connecting portion connected to the first configuration area and the second configuration area;
a first conductive terminal set configured to be located on the first configuration area and electrically connected to the bus bar body; and
a second conductive terminal set configured to be located on the second configuration area, electrically connected to the bus bar body,
wherein the bus bar body comprises a first conductive plate, a second conductive plate and an insulating plate, and the insulating plate is sandwiched between the first conductive plate and the second conductive plate to fixedly bond the first conductive plate and the second conductive plate together, the second conductive plate partially exposes a non-covered area of the first conductive plate in the first configuration area.

17. The bus bar connection assembly of claim 16, wherein the second conductive plate comprises at least one first through hole in the second configuration area, the insulating plate comprises at least one second through hole corresponding to the at least one first through hole to expose a part of a surface of the first conductive plate.

18. The bus bar connection assembly of claim 16, wherein the second conductive terminal set comprises at least one second-A conductive post and at least one second-B conductive post, and a protruding length of the at least one second-A conductive post in the second configuration area is smaller than a protruding length of the at least one second-B conductive post in the second configuration area.

19. The bus bar connection assembly of claim 16, wherein a top surface of the second configuration area, a top surface of the first configuration area and a top surface of the connecting portion are different in plane heights.

20. The bus bar connection assembly of claim 16, wherein the bus bar body further comprises a first insulating coating film coated on outer surfaces of the first conductive plate, and a second insulating coating film coated on outer surfaces of the second conductive plate.
